(19) United States
(12) Patent Application Publication
(10) Pub. No.: US 2003/0222094 A1
(43) Pub. Date: Dec. 4, 2003

(54) Thermal separating door in a vending machine

(76) Inventor: Munroe Chirnomas, Morris Township, NJ (US)

Correspondence Address: AUTOMATIC IMPULSE MACHINE DESIGN INC, LAWRENCE C EDELMAN, IP COUNSEL, 1 CORY RD, MORRIS TOWNSHIP, NJ, 07960, US

(21) Appl. No.: 10/375,280

(22) Filed: Feb. 26, 2003

Related U.S. Application Data
(60) Provisional application No. 60/360,129, filed on Feb. 26, 2002.

(51) Int. Cl. B65H 3/00; G07F 11/00; B65G 59/00

(52) U.S. Cl. 221/123; 221/150 R; 221/210

(57) ABSTRACT

A machine for vending articles, the machine including a housing, a storage area disposed within the housing and having a thermal barrier which separates the storage area from the remainder of the interior of the housing, a dispensing area having an access port disposed within the housing which allows a user of the machine to retrieve a dispensed article, a vertically oriented opening in the thermal barrier of the storage area, the opening dimensioned for allowing articles stored in the storage area to pass from the storage area to the dispensing area, and an article retrieval device nominally located in the storage area for moving articles from the storage area to the dispensing area via said opening. A door aligned with the opening is displaceable in response to movement of articles toward the opening by the article retrieval device.

### CROSS-REFERENCE TO RELATED APPLICATIONS

This application claims priority under 35USC 120 of U.S. Provisional Patent Application No. 60/360,129 filed Feb. 26, 2002, entitled “Thermal Separating Door In A Vending Machine”. The entire disclosure of this patent application is incorporated herein by reference in its entirety.

### SUMMARY OF THE INVENTION

The present invention provides a displaceable thermal separating door between a refrigerated compartment in a vending machine and a dispensing/customer pickup area.

### BRIEF DESCRIPTION OF THE DRAWINGS

The accompanying drawings, which are incorporated herein and constitute part of this specification, illustrate preferred and alternative embodiments and details of the invention, and together with the general description given above and the detailed description given below, serve to explain various features of the invention.

FIG. 1 is a side section view of a vending machine illustrating one embodiment of a thermal separating door constructed and operating in accordance with the principles of the present invention.

FIG. 2 is a side section view of a vending machine illustrating a further embodiment of a thermal separating door constructed and operating in accordance with the principles of the present invention.

### DETAILED DESCRIPTION OF THE PREFERRED EMBODIMENT

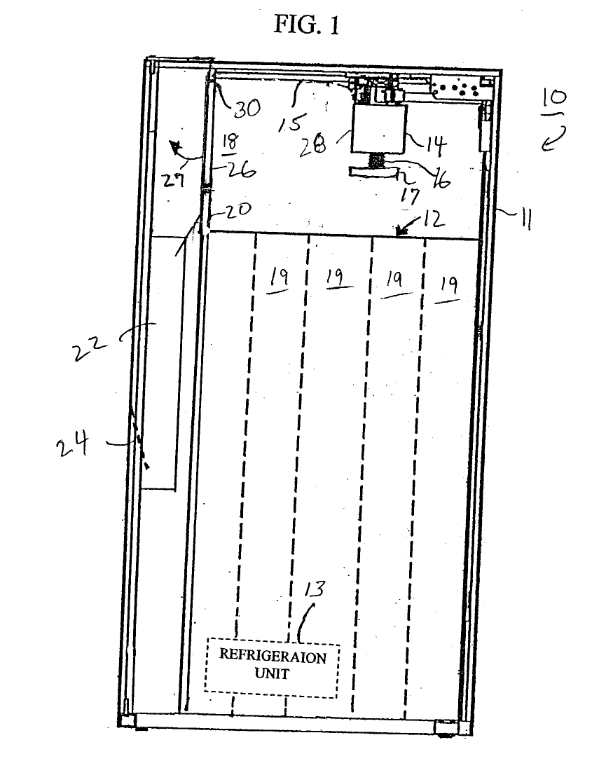

FIG. 1 illustrates a side section view of an article vending machine constructed and operating in accordance with the principles of the present invention. The vending machine generally includes a cabinet 11 upon which the conventional user interface components, such as a payment system, an article selection system and a display system are provided. Such conventional systems, being well known, are not shown or described further herein.

In accordance with the principles of the invention, the interior of cabinet 11 includes an article storage area 12, which can be cooled by a refrigeration unit 13 to approximately 35 to 50 degrees Fahrenheit for storing articles such as beverages, chocolate snacks or pastries, etc, or cooled to a greater degree, such as to minus 20 to minus 30 degrees Fahrenheit, for storing frozen articles, such as ice cream and/or other frozen foods. A robotic article retrieving device of known construction, such as described in my published PCT application WO 02/03340 (as well as, for example USSN 10/205,770 entitled Method and Apparatus for Positioning an Article Handling Device, filed Jul. 25, 2002 and incorporated herein by reference), is illustrated herein by carriage 14. As described in detail in the forenoted applications, carriage 14 is positioned in the front/back and left/right directions using sliding supports and racks 15 and pinion gears, as well known to those ordinary skill in this technology, to position a suction pickup head 16 to various X and Y coordinate positions within the article storage area. Carriage 14 also includes a drive system, such as a set of pinch rollers, not specifically shown but described in detail in my forenoted applications, for positioning a suction hose which has the article pickup head 16 positioned at the free end thereof, in the vertical, Z, direction for retrieving articles 17 from vertically aligned stacks 19 of the articles stored in the storage area 12.

After the article pickup head 16, with suction supplied thereto, has been driven into and then out of a particular stack 19 within storage area 12 so as to retrieve an article 17, carriage 14 is driven towards an opening 18 in a side wall 20 of the cooled storage area 12. Opening 18 allows for movement of the selected articles 17 from inside of storage area 12 to a customer pickup area 22, where the user can reach the article 17 deposited therein via a swinging access door 24 of conventional design.

In accordance with one aspect of the invention a displaceable thermal separator in the form, in the illustrated embodiment of a vertically oriented thermally insulated door 26, is provided within opening 18, so as to prevent the escape of cold air and the egress of warm air into cooled storage area 12, at all times during normal operation of machine 10 except during the movement of articles by pickup head 16 from storage area 12 into the customer pickup area 22.

In the illustrated embodiment a leading edge portion 28 of carriage 14 can either directly or via an opening linkage (not shown) engage door 26 so as to displace it in the direction shown by the arrow 27, so that the that article pickup head 16 can be positioned over the customer pickup area 20 and the selected article can then be released, such release being caused, for example by the cessation of the suction force in pickup head 16. Alternatively, the pinch rollers in carriage 14 can drive the suction hose in the vertical direction so that the article can be gently deposited at the bottom of area 22 before being released.

In this embodiment of the invention, as well as in other embodiments described below, many variations are possible and in fact contemplated. For example, although door 26 is shown to be hinged above opening 18 using a hinge 30, in an alternative embodiment it may be desirable to have door 26 hinged from below opening 18. Similarly, it is possible the door 26 could be positioned over opening 18 using slides, so that door 26 would slide either perpendicular to or parallel with the wall in which opening 18 is formed.

Furthermore, it should be clearly understood that the present invention is independent of the type of article dispensing device used, and other types are contemplated, such as one using an articulated arm, expanding scissor or even a telescoping arm (moving in rectangular or even polar coordinates), as well as article grippers of alternative constructions, such as one using a mechanical claw or scoop, a magnetic attracting device, a portable suction generator, etc. Still furthermore, door 26 need not be thermally insulated in order that the benefits of the invention are still realizable. Even furthermore, instead of having a linkage or direct contact by carriage 14 which causes the opening of door 26, a separate motor could be used to open door 26. This motor could be activated by a position sensor which indicates that carriage 14 has reached a predetermined position, or by a microprocessor that controls the overall operation of machine 10.

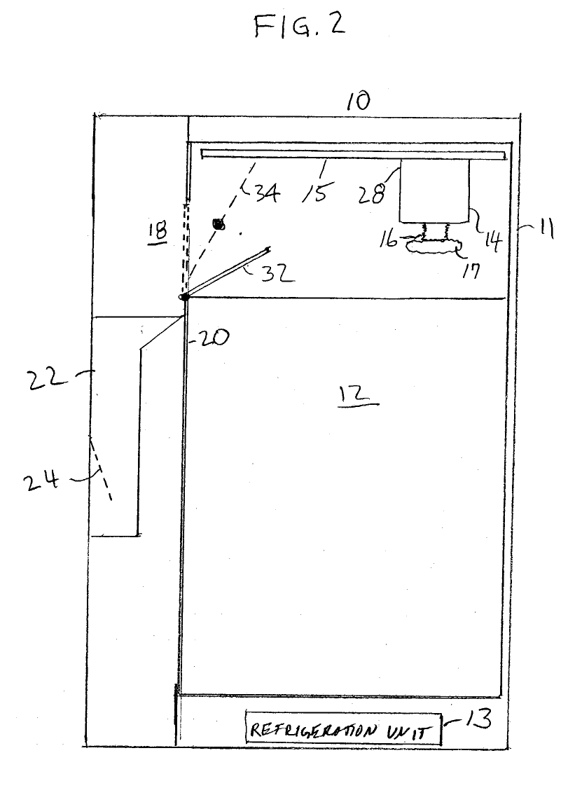

FIG. 2 illustrates an embodiment in accordance with another aspect of the invention, where opening 18 includes a displaceable thermal separator in the form of a door 32. A pivoting linkage mechanism 34 has one end which engages door 32 and other end which is selectively engaged by, for example, the leading edge 28 of the robotic carriage 14, as carriage 14 is driven towards opening 18. Operation of linkage 34 causes door 32 to tilt into storage area 12. With a door and linkage mechanism constructed in accordance with this aspect of the invention, carriage 14 need not exit the storage area 12 to properly deliver the article to the customer pickup area 22, and instead article pickup head 16 can release an article 17 while it is still positioned within storage area 12, and that article will fall upon and slide along the upper side of door 32 so as to gradually move in a sliding manner from inside storage area 12 to a position where it will fall into the customer pickup area 22. Thus, door 32 may also act as an upper portion of the customer area 12. If the articles are of a delicate nature, the customer pickup area 22 could be positioned closer to opening 18, or a passive or active elevator type mechanism could be provided within customer pickup area 22 for gently lowering the articles therein. Alternatively, the suction hose can be used to gently lower the articles in area 22.

With this embodiment of the invention, carriage 14 never leaves the refrigerated environment, thereby minimizing the formation of condensation thereon which may happen each time door 32 is opened, allowing for the possibility that outside air having a humidity greater then the cooled air inside area 12 may enter into area 12. Formation of condensation on the mechanical and electromechanical parts inside of area 12 may undesirably effect these parts, thereby reducing their reliability and operability.

Furthermore, with the present invention, dispensing of the articles is completed with less movement of carriage 14 being required, thereby enabling a more rapid completion of the dispensing operation.

While the present invention has been disclosed with reference to certain embodiments, numerous modifications, alterations and changes to the described embodiments, for example, as noted above, are possible without departing from the sphere and scope of the present invention. Accordingly, it is intended that the present invention not be limited to the described embodiments, but that it has the full scope defined by the above language and the claims which follow, as well as equivalents thereof.

1. A machine for vending articles, the machine comprising:
a housing;
a storage area disposed within the housing and having a thermal barrier which separates the storage area from the remainder of the interior of the housing;
a dispensing area having an access port disposed within the housing;
a vertically oriented opening in the thermal barrier of the storage area, dimensioned for allowing articles stored in the storage area to pass from the storage area to the dispensing area; and
an article retrieval device nominally located in the storage area for moving articles from the storage area to the dispensing area via said opening, further including, a door aligned with the opening, said door being displaceable in response to movement of articles toward said opening by said article retrieval device.

2. The machine of claim 1, further including a linkage mechanism coupled to the door for opening the door upon operation of the linkage.

3. The machine of claim 2, wherein the linkage mechanism is activated by contact of the article retrieval device as it is moved toward the door.

4. The machine of claim 3, wherein the door is tilted into the storage area upon activation by the linkage mechanism, and when so titled, a side of the door facing the article retrieving device is adapted to serve as a slide for moving articles positioned thereon by the article retrieving device through said opening and toward the dispensing area.
